(19) United States
(12) Patent Application Publication
(10) Pub. No.: US 2026/0061536 A1
(43) Pub. Date: Mar. 5, 2026

(54) MACHINE TOOL HAVING TWO MACHINING UNITS MOVABLE ALONG A LONG X AXIS

(71) Applicant: Schwäbische Werkzeugmaschinen GmbH, Schramberg-Waldmoessingen (DE)

(72) Inventor: Stefan Weber, Boesingen (DE)

(73) Assignee: Schwäbische Werkzeugmaschinen GmbH, Schramberg-Waldmoessingen (DE)

(21) Appl. No.: 19/291,324

(22) Filed: Aug. 5, 2025

(30) Foreign Application Priority Data
Aug. 28, 2024 (EP) EP24197026.8

(51) Int. Cl. B23Q 1/25

(52) U.S. Cl. CPC B23Q 1/25

(57) ABSTRACT

A machine tool for machining workpieces includes a left-hand machining space with a left-hand workpiece table for mounting left-hand workpieces and a right-hand machining space with a right-hand workpiece table for mounting right-hand workpieces. A left-hand machining unit, movable along an X axis, has a left-hand working spindle. A right-hand machining unit, movable along the X axis, has a right-hand working spindle. The left-hand machining unit is movable between a left-hand end position and the right-hand machining unit and the right-hand machining unit is movable between a right-hand end position and the left-hand machining unit. When the left-hand machining unit is in its left-hand end position and the right-hand machining unit has been moved until it is in abutment against the left-hand machining unit, the right-hand machining unit is arranged at least partially in the left-hand machining space in order to machine left-hand workpieces, and vice versa.

### CROSS-REFERENCE TO RELATED APPLICATIONS

This application claims priority to European Patent Application No. EP 24 197 026.8 filed August 28, 2024, the entire contents of which are hereby incorporated in full by this reference.

### DESCRIPTION

### FIELD OF THE INVENTION

The invention relates to a machine tool for, in particular, machining workpieces, comprising at least one working space and at least one machining unit for machining the workpieces arranged in the working space.

### BACKGROUND OF THE INVENTION

Machine tools of this kind are well known.

### SUMMARY OF THE INVENTION

Compared therewith, the present invention addresses the problem of specifying a machine tool that is as versatile as possible with regard to workpiece machining. In particular, a tool change or loading and unloading should take place as simultaneously as possible.

This problem is solved according to the invention by a machine tool for machining workpieces, comprising:

a left-hand machining space with a left-hand workpiece table for mounting left-hand workpieces and a right-hand machining space with a right-hand workpiece table for mounting right-hand workpieces; and

a left-hand machining unit, movable along an X axis, with a left-hand working spindle for machining workpieces, and a right-hand machining unit, movable along the X axis, with a right-hand working spindle for machining workpieces, wherein the left-hand machining unit is movable between a left-hand end position and the right-hand machining unit and the right-hand machining unit is movable between a right-hand end position and the left-hand machining unit;

wherein, when the left-hand machining unit is in its left-hand end position and the right-hand machining unit has been moved until it is in abutment against the left-hand machining unit, the right-hand machining unit is arranged at least partially in the left-hand machining space in order to machine left-hand workpieces and/or, when the right-hand machining unit is in its right-hand end position and the left-hand machining unit has been moved until it is in abutment against the right-hand machining unit, the left-hand machining unit is arranged at least partially in the right-hand machining space in order to machine right-hand workpieces.

According to the invention, two machining units that are movable along a long X axis and two workpiece tables that are spaced apart in the X direction are provided, with the result that, selectively, either separate machining of workpieces in the respective working space only by the associated machining unit or joint machining of workpieces in a working space by both machining units is made possible.

The left-hand working spindle and the right-hand working spindle can be the same size or different sizes or different powers. In the latter case, it is possible, for example, for the larger, more powerful spindle on the right-hand side to provide “help” in the left-hand machining space.

When the left-hand machining unit is in its left-hand end position, the right-hand working spindle overlaps the left-hand machining space preferably to an extent of at least 50%, particularly preferably at least 70%, in the X direction. When the right-hand machining unit is in its right-hand end position, the left-hand working spindle overlaps the right-hand machining space preferably to an extent of at least 50%, particularly preferably at least 70%, in the X direction.

Preferably, the X width of the left-hand machining space and the X width of the right-hand machining space are respectively at least twice as large as the minimum possible X spindle spacing of the two working spindles. As a result of this measure, it is possible, in the case of joint machining, for the two working spindles to respectively be able to overlap at least 50% of the X width of a working space. The X width of the left-hand machining space and the X width of the right-hand machining space are advantageously the same size, but may also be different.

The machine tool preferably has at least one bottom rail, extending along the X axis, in which both the left-hand machining unit, in particular, a left-hand travelling column of the left-hand machining unit, and the right-hand machining unit, in particular, a right-hand travelling column of the right-hand machining unit, are guided so as to be movable in the X direction. In the case of travelling columns, the machine tool is a machine tool with a travelling column design.

The two machining units can be guided so as to be movable in a common bottom rail or respectively in separate bottom rails, wherein, in the latter case, the two machining units cannot travel past one another in the X direction. For example, the left-hand travelling column and the right-hand travelling column are each L-shaped with a short horizontal leg, which is guided so as to be movable in the at least one bottom rail, and with a long vertical leg, which carries the working spindle, and are arranged along the X axis with the free ends of their horizontal legs facing one another or facing away from one another. Advantageously, the left-hand travelling column and the right-hand travelling column can be formed in a mirror-symmetric manner to one another.

In one preferred embodiment of the invention, the left-hand end position of the left-hand machining unit is the left-most machining position of the left-hand machining unit and/or the right-hand end position of the right-hand machining unit is the right-most machining position of the right-hand machining unit.

In another, particularly preferred embodiment of the invention, the left-hand end position of the left-hand machining unit is arranged further to the left than the left-most machining position of the left-hand machining unit and/or the right-hand end position of the right-hand machining unit is arranged further to the right than the right-most machining position of the right-hand machining unit. As a result, this allows, during a tool change of the one machining unit in the working space thereof, simultaneous machining by the other machining unit and simultaneous loading and unloading of workpieces in the other working space. For example, the left-hand end position of the left-hand machining unit can be a left-hand tool-change position for changing tools from a tool magazine into the left-hand machining unit and vice versa and/or the right-hand end position of the right-hand machining unit can be a right-hand tool-change position for changing tools from a tool magazine into the right-hand machining unit and vice versa. Advantageously, the machine tool has a left-hand tool magazine which changes tools into and out of the left-hand machining unit, and a right-hand tool magazine, which changes tools into and out of the right-hand machining unit.

Preferably, provision is made for a left-hand pivoting carrier, which is mounted in the left-hand machining space so as to be rotatable about an A axis parallel to the X axis, to have the left-hand workpiece table and/or a right-hand pivoting carrier, which is mounted in the right-hand machining space so as to be rotatable about an A axis parallel to the X axis, to have the right-hand workpiece table. Thus, workpieces can be placed on the workpiece table from above – manually or by means of a robot – and are then, after the pivoting carrier has been rotated through 180°, machined in a manner hanging downward, with the result that the chips that arise during machining can drop down in an unimpeded manner. In addition, the left-hand workpiece table can be mounted on the left-hand pivoting carrier and/or the right-hand workpiece table can be mounted on the right-hand pivoting carrier in each case so as to be rotatable about a C axis at right angles to the A axis.

The invention also relates to a method for machining workpieces on a machine tool as described above, wherein, in a first operating mode, left-hand workpieces are machined only by the left-hand working spindle and right-hand workpieces are machined only by the right-hand working spindle, and wherein, in a second operating mode, left-hand workpieces are machined both by the left-hand working spindle and by the right-hand working spindle and/or right-hand workpieces are machined both by the left-hand working spindle and by the right-hand working spindle.

Optionally, in a third operating mode, one of the two machining units can be moved, for a tool change, into its respective end position and, parallel to main time, right-hand and/or left-hand workpieces can be machined by the other machining unit.

Further advantages of the invention will become apparent from the description and the drawing. The embodiment shown and described should not be understood as being a definitive list, but rather has an exemplary nature for describing the invention.

### BRIEF DESCRIPTION OF THE DRAWINGS

In the drawings:

FIG. 1 shows a plan view from above of a machine tool according to the invention, comprising a left-hand and a right-hand machining unit, which are movable along a long X axis, wherein the left-hand machining unit is arranged in a left-hand machining space and the right-hand machining unit is arranged in a right-hand machining space;

FIG. 2 shows a frontal view of the left-hand and of the right-hand machining space;

FIG. 3 shows a perspective view of the left-hand machining unit;

FIGS. 4a, 4b show the machine tool from FIG. 1, wherein the left-hand and the right-hand machining unit are both arranged in the left-hand machining space (FIG. 4a) or are both arranged in the right-hand machining space (FIG. 4b); and

FIGS. 5a, 5b show the machine tool from FIG. 1, wherein the left-hand machining unit is arranged in a left-hand tool-change position and the right-hand machining unit is arranged in the left-hand machining space in abutment against the left-hand machining unit (FIG. 5a) and wherein the right-hand machining unit is arranged in a right-hand tool-change position and the left-hand machining unit is arranged in the right-hand machining space in abutment against the right-hand machining unit (FIG. 5b).

### DETAILED DESCRIPTION OF EMBODIMENTS OF THE INVENTION

The machine tool 1, shown in FIG. 1, for machining workpieces comprises a left-hand machining space 11a with a left-hand workpiece table 12a, which in this case is round, for mounting left-hand workpieces 2a and a right-hand machining space 11b with a right-hand workpiece table 12b, which in this case is round, for mounting right-hand workpieces 2b, and a left-hand machining unit 10a, movable along a long X axis, with a left-hand working spindle 14a for machining workpieces 2a, 2b and a right-hand machining unit 10b, movable along the long X axis, with a right-hand working spindle 14b for machining workpieces 2a, 2b. The X width of the left-hand machining space 11a and the X width of the right-hand machining space 11b are the same size in the exemplary embodiment shown, but may also be different in exemplary embodiments that are not shown.

The long X axis is formed by a bottom rail 16, which extends in the machine frame 15, in this case in the machine pedestal, of the machine tool 1 and in which both the left-hand machining unit 10a, in this case a left-hand travelling column 13a of the left-hand machining unit 10a, and the right-hand machining unit 10b, in this case a right-hand travelling column 13b of the right-hand machining unit 10b, are guided so as to be movable in the X direction. The machine tool 1 shown is thus a machine tool with a travelling column design.

In the machine frame 15, as shown in FIG. 2, a left-hand pivoting carrier 17a is arranged in the left-hand machining space 11a and a right-hand pivoting carrier 17b is arranged in the right-hand machining space 11b, in each case so as to be rotatable about an A axis parallel to the X axis. The left-hand pivoting carrier 17a has the left-hand workpiece table 12a and the right-hand pivoting carrier 17b has the right-hand workpiece table 12b. In addition, the left-hand workpiece table 12a can be mounted on the left-hand pivoting carrier 17a and the right-hand workpiece table 12b can be arranged on the right-hand pivoting carrier 17b, in each case so as to be rotatable about a C axis at right angles to the A axis.

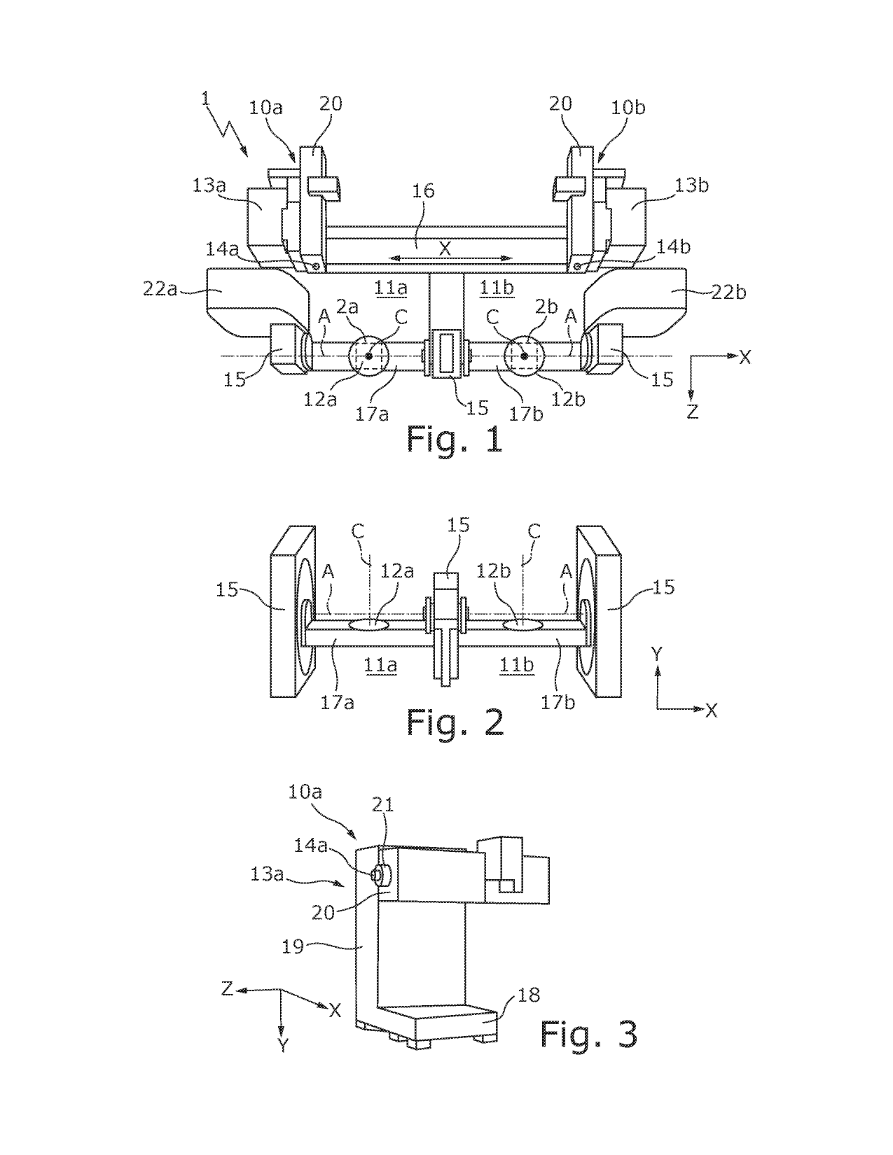

As is shown in FIG. 3 by way of the example of the left-hand machining unit 10a, the two travelling columns 13a, 13b are each L-shaped with a horizontal leg 18, in this case short, which is guided so as to be movable in the bottom rail 16, and with a vertical leg 19, in this case long, which carries the respective working spindle 14a, 14b. On the vertical leg 19, the working spindle 14a, 14b is guided so as to be movable in the Y and Z direction via corresponding slides 20, 21. The two travelling columns 13a, 13b have the free ends of their horizontal legs 18 facing one another along the X axis and are preferably, as shown here, formed in a mirror-symmetric manner to one another.

The left-hand machining unit 10a is movable along the X axis between a left-hand end position and the right-hand machining unit 10b. The left-hand end position may be, for example, the left-most machining position, in the left-hand machining space 11a, of the left-hand machining unit 10a or lie further to the left than this left-most machining position. The right-hand machining unit 10b is movable along the X axis between a right-hand end position and the left-hand machining unit 10a. The right-hand end position may be, for example, the right-most machining position, in the right-hand machining space 11b, of the right-hand machining unit 10b or lie further to the right than this right-most machining position.

In FIG. 1, the left-hand machining unit 10a is shown in its left-most machining position in the left-hand machining space 11a and the right-hand machining unit 10b is shown in its right-most machining position in the right-hand machining space 11b.

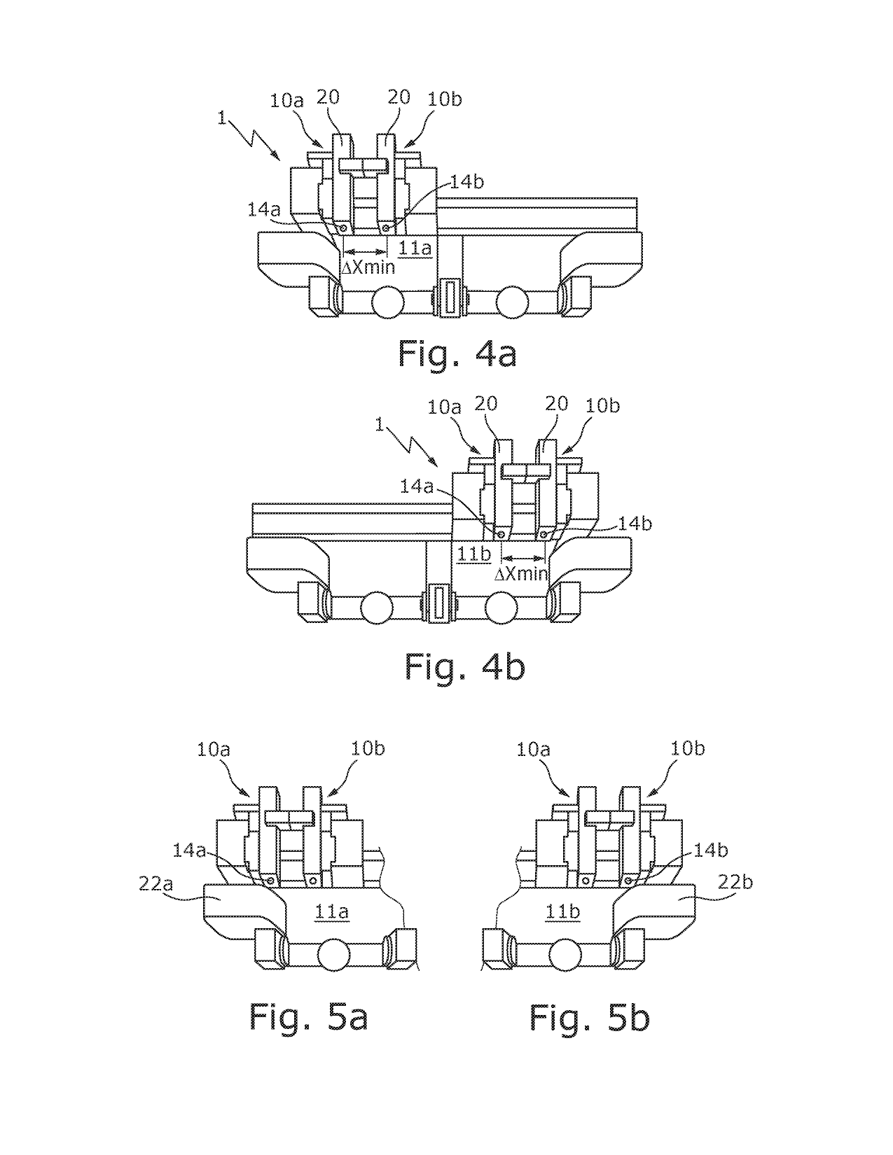

In FIG. 4a, the left-hand machining unit 10a is in its left-most machining position, and the right-hand machining unit 10b has been moved to the left until it is in abutment against the left-hand machining unit 10a. In this abutment position, the right-hand working spindle 14b overlaps the left-hand machining space 11a preferably to an extent of at least 50%, particularly preferably at least 70%, in the X direction.

In FIG. 4b, the right-hand machining unit 10b is in its right-most machining position, and the left-hand machining unit 10a has been moved to the right until it is in abutment against the right-hand machining unit 10b. In this abutment position, the left-hand working spindle 14a overlaps the right-hand machining space 11b preferably to an extent of at least 50%, particularly preferably at least 70%, in the X direction.

The minimum possible X spindle spacing of the two working spindles 14a, 14b, i.e., when the two machining units 10a, 10b are in abutment against one another, is denoted ΔXmin in FIGS. 4a, 4b. Preferably, the X width of the left-hand machining space 11a and the X width of the right-hand machining space 11b are each at least twice as large as the minimum possible X spindle spacing ΔXmin.

In FIG. 5a, the left-hand machining unit 10a is in a left-hand end position which is arranged further to the left than its left-most machining position and forms a left-hand tool-change position, in which tools can be changed into and out of the left-hand machining unit 10a from a left-hand tool magazine 22a. The right-hand machining unit 10b has been moved to the left until it is in abutment against the left-hand machining unit 10a.

In FIG. 5b, the right-hand machining unit 10b is in a right-hand end position which is arranged further to the right than its right-most machining position and forms a right-hand tool-change position, in which tools can be changed into and out of the right-hand machining unit 10b from a right-hand tool magazine 22b. The left-hand machining unit 10a has been moved to the right until it is in abutment against the right-hand machining unit 10b.

In FIG. 1, the machine tool 1 is in a first operating mode (“separate machining”), in which left-hand workpieces 2a are machined only by the left-hand working spindle 14a and right-hand workpieces 2b are machined only by the right-hand working spindle 14b.

In FIGS. 4a, 4b, the machine tool 1 is in a second operating mode (“joint machining”), in which left-hand workpieces 2a are machined both by the left-hand working spindle 14a and by the right-hand working spindle 14b (FIG. 4a) or right-hand workpieces 2b are machined both by the left-hand working spindle 14a and by the right-hand working spindle 14b (FIG. 4b). In the working space in which no machining is taking place, loading or unloading of workpieces can take place parallel to main time.

In FIGS. 5a, 5b, the machine tool 1 is in a third operating mode, in which one of the two machining units 10a, 10b has been moved for a tool change into its respective end or tool-change position and, parallel to main time, right-hand and/or left-hand workpieces 2a, 2b are machined by the other machining unit.

Rather than separately as in the exemplary embodiment shown, the left-hand and the right-hand working space 11a, 11b can alternatively also be formed by the left-hand and the right-hand side of a single working space.

Rather than separately as in the exemplary embodiment shown, the left-hand and the right-hand workpiece table 17a, 17b can alternatively also be formed by the left-hand and the right-hand side of a single workpiece table.

Rather than separately as in the exemplary embodiment shown, the left-hand and the right-hand pivoting carrier 17a, 17b can alternatively also be formed by the left-hand and the right-hand side of a single pivoting carrier.

What is claimed is:

1. A machine tool for machining workpieces, comprising:
a left-hand machining space with a left-hand workpiece table configured for mounting left-hand workpieces and a right-hand machining space with a right-hand workpiece table configured for mounting right-hand workpieces; and
a left-hand machining unit, movable along an X axis, with a left-hand working spindle configured for machining workpieces, and a right-hand machining unit, movable along the X axis, with a right-hand working spindle configured for machining workpieces, wherein the left-hand machining unit is movable between a left-hand end position and the right-hand machining unit and the right-hand machining unit is movable between a right-hand end position and the left-hand machining unit;
wherein, when the left-hand machining unit is in its left-hand end position and the right-hand machining unit has been moved until it is in abutment against the left-hand machining unit, the right-hand machining unit is arranged at least partially in the left-hand machining space in order to machine left-hand workpieces and/or, when the right-hand machining unit is in its right-hand end position and the left-hand machining unit has been moved until it is in abutment against the right-hand machining unit, the left-hand machining unit is arranged at least partially in the right-hand machining space in order to machine right-hand workpieces.

2. The machine tool according to claim 1, wherein, when the left-hand machining unit is in its left-hand end position, the right-hand working spindle overlaps the left-hand machining space to an extent of at least 50% in the X direction and/or, when the right-hand machining unit is in its right-hand end position, the left-hand working spindle overlaps the right-hand machining space to an extent of at least 50% in the X direction.

3. The machine tool according to claim 1, wherein, when the left-hand machining unit is in its left-hand end position, the right-hand working spindle overlaps the left-hand machining space to an extent of at least 70% in the X direction and/or, when the right-hand machining unit is in its right-hand end position, the left-hand working spindle overlaps the right-hand machining space to an extent of at least 70% in the X direction.

4. The machine tool according to claim 1, wherein the X width of the left-hand machining space is at least twice as large as the minimum possible X spindle spacing of the two working spindles and/or the X width of the right-hand machining space is at least twice as large as the minimum possible X spindle spacing of the two working spindles.

5. The machine tool according to claim 1, wherein the X width of the left-hand machining space and the X width of the right-hand machining space are the same.

6. The machine tool according to claim 1, wherein least one bottom rail extends along the X axis, in which both the left-hand machining unit, being a left-hand travelling column of the left-hand machining unit, and the right-hand machining unit, being a right-hand travelling column of the right-hand machining unit, are guided so as to be movable in the X direction.

7. The machine tool according to claim 6, wherein the left-hand travelling column and the right-hand travelling column are each L-shaped with a horizontal leg, which is guided so as to be movable in the at least one bottom rail, and with a vertical leg, which carries the working spindle, and are arranged along the X axis with the free ends of their horizontal legs facing one another or facing away from one another.

8. The machine tool according to claim 6, wherein the left-hand travelling column and the right-hand travelling column are formed in a mirror-symmetric manner to one another.

9. The machine tool according to claim 1, wherein the left-hand end position of the left-hand machining unit is the left-most machining position of the left-hand machining unit and/or the right-hand end position of the right-hand machining unit is the right-most machining position of the right-hand machining unit.

10. The machine tool according to claim 1, wherein the left-hand end position of the left-hand machining unit is arranged further to the left than the left-most machining position of the left-hand machining unit and/or the right-hand end position of the right-hand machining unit is arranged further to the right than the right-most machining position of the right-hand machining unit.

11. The machine tool according to claim 10, wherein the left-hand end position of the left-hand machining unit is a left-hand tool-change position for changing tools from a tool magazine into the left-hand machining unit and vice versa and/or the right-hand end position of the right-hand machining unit is a right-hand tool-change position for changing tools from a tool magazine into the right-hand machining unit and vice versa.

12. The machine tool according to claim 11, wherein a left-hand tool magazine changes tools into and out of the left-hand machining unit, and a right-hand tool magazine changes tools into and out of the right-hand machining unit.

13. The machine tool according to claim 1, wherein a left-hand pivoting carrier, which is mounted in the left-hand machining space so as to be rotatable about an A axis parallel to the X axis, has the left-hand workpiece table and/or a right-hand pivoting carrier, which is mounted in the right-hand machining space so as to be rotatable about an A axis parallel to the X axis, has the right-hand workpiece table.

14. The machine tool according to claim 13, wherein the left-hand workpiece table is mounted on the left-hand pivoting carrier to be rotatable about a C axis at right angles to the A axis and/or the right-hand workpiece table is mounted on the right-hand pivoting carrier to be rotatable about a C axis at right-angles to the A axis.

15. A method for machining workpieces on the machine tool according to claim 1, wherein, in a first operating mode, left-hand workpieces are machined only by the left-hand working spindle and right-hand workpieces are machined only by the right-hand working spindle, and
wherein, in a second operating mode, left-hand workpieces are machined both by the left-hand working spindle and by the right-hand working spindle and/or right-hand workpieces are machined both by the left-hand working spindle and by the right-hand working spindle.

16. The method according to claim 15, wherein, in a third operating mode, one of the two machining units is moved, for a tool change, into its respective end position and, parallel to main time, right-hand and/or left-hand workpieces are machined by the other machining unit.

17. A machine tool for machining workpieces, comprising:
a left-hand machining space with a left-hand workpiece table configured for mounting left-hand workpieces and a right-hand machining space with a right-hand workpiece table configured for mounting right-hand workpieces; and
a left-hand machining unit, movable along an X axis, with a left-hand working spindle configured for machining workpieces, and a right-hand machining unit, movable along the X axis, with a right-hand working spindle configured for machining workpieces, wherein the left-hand machining unit is movable between a left-hand end position and the right-hand machining unit and the right-hand machining unit is movable between a right-hand end position and the left-hand machining unit;
wherein, when the left-hand machining unit is in its left-hand end position and the right-hand machining unit has been moved until it is in abutment against the left-hand machining unit, the right-hand machining unit is arranged at least partially in the left-hand machining space in order to machine left-hand workpieces and/or, when the right-hand machining unit is in its right-hand end position and the left-hand machining unit has been moved until it is in abutment against the right-hand machining unit, the left-hand machining unit is arranged at least partially in the right-hand machining space in order to machine right-hand workpieces;
wherein least one bottom rail extends along the X axis, in which both a left-hand travelling column of the left-hand machining unit and a right-hand travelling column of the right-hand machining unit are guided so as to be movable in the X direction; and
wherein the left-hand travelling column and the right-hand travelling column are each L-shaped with a short horizontal leg, which is guided so as to be movable in the at least one bottom rail, and with a long vertical leg, which carries the working spindle, and are arranged along the X axis with the free ends of their horizontal legs facing one another.
